(19) United States
(12) Patent Application Publication
(10) Pub. No.: US 2026/0228766 A1
(43) Pub. Date: Aug. 6, 2026

(54) SYSTEMS AND METHODS FOR DETERMINING ATTRIBUTION BY APPLYING MULTIPLE STIMULI SOURCES TO A STREAM OF DATA

(71) Applicant: VEIL GLOBAL TECHNOLGIES, INC., Saint Louis, MO (US)

(72) Inventors: James DICKMAN, Saint Louis, MO (US); Brian HANDRIGAN, Saint Louis, MO (US); Jeffrey LINIHAN, Saint Louis, MO (US); Mikayla PUGEL, Saint Louis, MO (US); Andrew ELLISON, Saint Louis, MO (US)

(21) Appl. No.: 19/150,500

(22) PCT Filed: Jan. 24, 2023
(86) PCT No.: PCT/US2023/061122

§ 371 Date: Jul. 23, 2025

(51) Int. Cl. G06Q 30/0202; G06Q 30/0242

(52) U.S. Cl. CPC G06Q 30/02024; G06Q 30/0246

(57) ABSTRACT

A marketing campaign evaluation method involves using one or more machine learning models that predict traffic to a website based on multiple variables, or attributable events, that can influence a marketing campaign. A machine learning model may predict traffic to a website in the absence of attributable events, which serves as a baseline from which to compare traffic to a website when an attributable event (e.g., a commercial being presented) occurs. Another machine learning model may predict traffic to a website based on one or more changeable variables, which enables a user to evaluate the various aspects of a current marketing campaign or a proposed future marketing campaign.

### TECHNICAL FIELD

Aspects of the present disclosure relate to computing devices and hardware involved in the application of machine learning to evaluate marketing campaigns by determining and/or predicting the outcome of certain variables in a marketing campaign.

### BACKGROUND

Typical methods for calculating and/or forecasting marketing campaign analytics use one stream of data (i.e., the historical data) for calculating the outcome of a marketing campaign that has occurred or predicting the outcome of a proposed marketing campaign. There may be many stimuli, however, that influence an outcome of a marketing campaign that are not taken into account in a method using only a single stream of historical data. As such, when using only a single stream of historical data, it can be difficult to accurately determine the difference between what happened as a result of an attributable event (e.g., a TV commercial airing) and what would have occurred in the absence of the attributable event. It can likewise be difficult to accurately predict what would occur should an attributable event happen (e.g., a content provider deciding whether to air a TV commercial) and some or all of the stimuli influencing the outcome of the marketing campaign were to change. These difficulties lead to inaccurate assumptions and understandings, and ultimately reportings, of any marketing analytics generated using such typical methods.

It is with these technical problems, among others, that aspects of the present application were conceived.

### SUMMARY

The present application involves systems, methods, and non-transitory computer-readable mediums for machine learning-based marketing campaign evaluations. In a first aspect, a method for evaluating a marketing campaign includes receiving an electronic signal indicating detection of an attributable event occurring at a firsts computing device; predicting, using a machine learning model, a predicted amount of web traffic to a website, over a period of time subsequent to receiving the electronic signal, had the attributable event not occurred; receiving electronic data indicating an actual amount of web traffic to the website over the period of time subsequent to receiving the electronic signal; generating an indication based on comparing the actual amount of web traffic with the predicted amount of web traffic; and storing the indication in a memory of a second computing device.

In a second aspect, which can be combined with any other aspect herein (e.g., the 1^{st} aspect) unless stated otherwise, the method further includes training the machine learning model, which includes receiving a time series of past web traffic to the website prior to receiving the electronic signal; identifying a time window associated with an attributable event in the time series; removing the past web traffic corresponding to the identified time window from the time series to thereby form a training data set; and providing the training data set to the machine learning model.

In a third aspect, which can be combined with any other aspect herein (e.g., the 1^{st} or 2^{nd} aspects) unless stated otherwise, the attributable event is one included in the group consisting of: an advertisement being presented in general, a type of advertisement, a manner in which an advertisement is presented, the content discussed within a TV program during which the advertisement is presented, an associated sentiment of the TV program content, a search and social platform paid advertisement bid, a weather event, a political event, and a cultural event.

In a fourth aspect, which can be combined with any other aspect herein (e.g., the 3^{rd} aspect) unless stated otherwise, the content is a phrase or keyword.

In a fifth aspect, which can be combined with any other aspect herein (e.g., the 3^{rd} or 4^{th} aspects) unless stated otherwise, the type of advertisement is a TV commercial.

In a sixth aspect, which can be combined with any other aspect herein (e.g., the 3^{rd} through the 5^{th} aspects) unless stated otherwise, generating the indication includes determining an attribution value for the attributable event based on comparing the actual amount of web traffic with the predicted amount of web traffic.

In a seventh aspect, which can be combined with any other aspect herein (e.g., the 1^{st} through the 6^{th} aspects) unless stated otherwise, the method further includes training a second machine learning model based on the comparing of the actual amount of web traffic with the predicted amount of web traffic.

In an eighth aspect, which can be combined with any other aspect herein (e.g., the 1^{st} through the 7^{th} aspects) unless stated otherwise, the method further includes predicting, using a second machine learning model, a second predicted amount of web traffic to the website over the period of time subsequent to receiving the electronic signal with one or more variables of the marketing campaign being changed, wherein the indication is generated based additionally on the second predicted amount of web traffic.

In a ninth aspect, which can be combined with any other aspect herein (e.g., the 8^{th} aspect) unless stated otherwise, the variables of the marketing campaign include at least one in the group consisting of: a type of advertisement, a TV market within which an advertisement is shown, a particular network affiliate or streaming platform through which an advertisement is ran, a particular channel on which an advertisement is presented, a particular time during which an advertisement is presented, content being presented in an advertisement, the TV program an advertisement runs during, the content being discussed within the TV program, associated sentiment of the TV program content, a percent reach to which an advertisement was shown, the search engine an advertisement is run on, the social media platform an advertisement is run on, characteristics of the audience, household, or individual to which an advertisement is being shown, and the particular frequency of which an advertisement is shown to a certain audience, household or individual.

In a tenth aspect, which can be combined with any other aspect herein (e.g., the 8^{th} or 9^{th} aspects) unless stated otherwise, the second machine learning model is trained with the generated indication.

In a eleventh aspect, which can be combined with any other aspect herein (e.g., the 2^{nd} through the 10^{th} aspects) unless stated otherwise, a system for evaluating a marketing campaign includes a memory and a processor in communication with the memory. The processor is configured to receive an electronic signal indicating detection of an attributable event occurring at a computing device; predict, using a machine learning model, a predicted amount of web traffic to a website, over a period of time subsequent to receiving the electronic signal, had the attributable event not occurred; receive electronic data indicating an actual amount of web traffic to the website over the period of time subsequent to receiving the electronic signal; generate an indication based on comparing the actual amount of web traffic with the predicted amount of web traffic; and store the indication in the memory.

In a twelfth aspect, which can be combined with any other aspect herein (e.g., the 1^{st} through the 11^{th} aspects) unless stated otherwise, the machine learning model is trained based on a time series of past web traffic to the website in which the web traffic associated with past attributable events is removed from the time series.

In a thirteenth aspect, which can be combined with any other aspect herein (e.g., the 11^{th} or 12^{th} aspect) unless stated otherwise, the processor is further configured to predict, using a second machine learning model, a second predicted amount of web traffic to the website over a period of time subsequent to generating the indication.

In a fourteenth aspect, which can be combined with any other aspect herein (e.g., the 1^{st} through the 13^{th} aspects) unless stated otherwise, the machine learning model is a negative binomial distribution.

In a fifteenth aspect, which can be combined with any other aspect herein (e.g., the 1^{st} through the 14^{th} aspects) unless stated otherwise, the attributable event is a TV commercial airing, and wherein the indication includes a lift attribution value for the TV commercial.

In a sixteenth aspect, which can be combined with any other aspect herein (e.g., the 11^{th} through the 15^{th} aspects) unless stated otherwise, the processor is further configured to predict, using a second machine learning model, a second predicted amount of web traffic to the website over the period of time subsequent to receiving the electronic signal with one or more variables of the marketing campaign being changed, wherein the indication is generated based on the second predicted amount of web traffic.

In a seventeenth aspect, which can be combined with any other aspect herein (e.g., the 16^{th} aspect) unless stated otherwise, the second machine learning model is trained based on the comparing of the actual amount of web traffic with the predicted amount of web traffic.

In an eighteenth aspect, which can be combined with any other aspect herein (e.g., the) unless stated otherwise, a non-transitory, computer-readable medium stores instructions, which when executed by a processor, cause the processor to: receive an electronic signal indicating detection of an attributable event occurring at a first computing device; predict, using a machine learning model, a predicted amount of web traffic to a website, over a period of time subsequent to receiving the electronic signal, had the attributable event not occurred; receive electronic data indicating an actual amount of web traffic to the website over the period of time subsequent to receiving the electronic signal; generate an indication based on comparing the actual amount of web traffic with the predicted amount of web traffic; and store the indication a memory of a second computing device.

In a nineteenth aspect, which can be combined with any other aspect herein (e.g., the 1^{st} through the 18^{th} aspects) unless stated otherwise, the machine learning model is trained only on web traffic data associated with the website.

In a twentieth aspect, which can be combined with any other aspect herein (e.g., the 1^{st} through the 19^{th} aspects) unless stated otherwise, the indication includes at least one metric in the group consisting of: an amount in sales associated with the attributable event, a customer conversion rate associated with the attributable event, and lift attribution of the attributable event.

### BRIEF DESCRIPTION OF THE DRAWINGS

The foregoing and other objects, features, and advantages of the present disclosure set forth herein will be apparent from the following description of particular embodiments of the inventive concepts, as illustrated in the accompanying drawings. Also, in the drawings the same reference characters refer to the same parts throughout the different views. The drawings depict only typical embodiments of the present disclosure and, therefore, are not to be considered limiting in scope.

FIG. 1 illustrates a box diagram of an example system for generating marketing campaign analytics, according to an aspect of the present disclosure.

FIG. 2 illustrates a flow chart of an example process for generating an indication, according to an aspect of the present disclosure.

FIG. 3 illustrates a flow chart of an example process for training a machine learning model that predicts baseline web traffic for a website, according to an aspect of the present disclosure.

FIG. 4 illustrates a flow chart of an example process for predicting an amount of web traffic to a website based on input marketing campaign variables, according to an aspect of the present disclosure.

FIG. 5 illustrates a block diagram of a computing and networking environment, according to an aspect of the present disclosure.

### DETAILED DESCRIPTION

The present application involves new and innovative machine learning-based prediction methods for evaluating marketing campaigns. For example, online advertisers are typically interested in understanding the effectiveness of their marketing campaigns (e.g., sales, customer conversion) and the factors that drive traffic to their websites and/or sales (e.g., attribution). In another example, online advertisers are typically interested in evaluating proposed marketing campaigns in an effort to avoid launching an ineffective marketing campaign. There are many variables, however, that can affect a marketing campaign's outcome, therefore making it technologically difficult to accurately evaluate a marketing campaign's effectiveness and how each of those variables contribute to the effectiveness. For instance, a marketing campaign's effectiveness may be influenced by a type of advertisement used, a medium and/or channel on which the advertisement is presented, a time of day and/or year the advertisement is presented, viewers of the advertisement, bid adjustment amounts on social media platforms, and weather events to name a few.

Typical methods for calculating and/or forecasting marketing analytics (e.g., amount in sales, conversion of customers, lift attribution, etc.) are technically limited because they only use one stream of data for calculating the outcome of a marketing campaign that has occurred or for predicting the outcome of a proposed marketing campaign. The one stream of data used in typical methods can be historical data that only represents one type of attributable event which is assumed by marketers to be the primary variable affecting marketing outcomes, such as a stream of TV commercial airings. This historical data, however, does not capture the many variables that influence a marketing campaign outcome and therefore typical methods are technically limited in accurately determining the difference between what happened as a result of an attributable event (e.g., a TV commercial airing) and what would have occurred in the absence of the attributable event. Typical methods are likewise technically limited in accurately predicting what would occur should an attributable event happen and some or all of the stimuli influencing the outcome of the marketing campaign were to change. These technical limitations of typical methods lead to inaccurate marketing campaign analytics and predictions generated using such typical methods.

Aspects of the present application solve the specific technical problems recited above, among others, by evaluating marketing campaigns using one or more machine learning models that predict traffic to a website based on multiple variables, or attributable events, that can influence a marketing campaign. For instance, the provided system may utilize a machine learning model that predicts traffic to a website in the absence of attributable events, which serves as a baseline from which to compare traffic to a website when an attributable event (e.g., a commercial being presented or a weather event) occurs. In such instances, the machine learning model may be trained with time series web traffic data that has web traffic corresponding to attributable events removed. Predicting a web traffic baseline in this way, and then comparing actual web traffic with the predicted web traffic, enables a user (e.g., an advertiser or a service provider) to determine the effect that an attributable event has on traffic to a website more accurately than with typical methods which rely solely on historical data.

In other instances, the provided system may utilize a machine learning model that predicts traffic to a website based on one or more changeable variables, which enables a user to evaluate the various aspects of a current marketing campaign or a proposed future marketing campaign. In such other instances, this machine learning model may be trained with output data comparing actual web traffic with predicted web traffic generated by the baseline prediction machine learning model. Stated differently, an attributable event's effect on web traffic can be determined by comparing actual web traffic with predicted web traffic, and by training a machine learning model on the web traffic effect of multiple different attributable events, the trained machine learning model can then predict web traffic based on any combination of attributable events. As such, the provided system can more accurately evaluate marketing campaigns with multiple data streams as compared to typical methods that utilize only a single data stream.

As used herein, an “attributable event” means any event that can be attributed to a change in web traffic to a website. For example, an attributable event can be, but is not limited to, an advertisement being presented in general; a type of advertisement presented (e.g., TV, over-the-top (OTT), radio, Internet, etc.); a manner in which an advertisement is presented, including: within a particular TV market or geographic context (e.g., the St. Louis, Missouri TV market, a particular zip code, a local cable TV zone, etc.), through a particular network affiliate or streaming platform (e.g., NBC, Fox, Hulu, etc.), on a particular channel, during a particular time of day, day, week, month, year, or season, with a particular keyword, phrase, image, etc., to a percent reach (e.g., a percentage of the US population), on a particular search engine, on a particular social media platform, to a particular demographic, psychographic, or other measurable characteristics of the audience, household, or individual, with a particular frequency to a certain audience, household or individual, or during a particular TV program; the content (e.g., topics, keywords, brands, people, political figures, etc.) being discussed within the TV program, and associated sentiment (e.g. positive or negative) of that content or discussion, or other metadata or categorization which may be commonly used to describe the program or program content (e.g. syndication status, the cast of the show, ratings, rankings, critiques, etc.), the coordination of paid advertising efforts on search and social platforms in sync with the advertising, a weather event, a political event, and a cultural event.

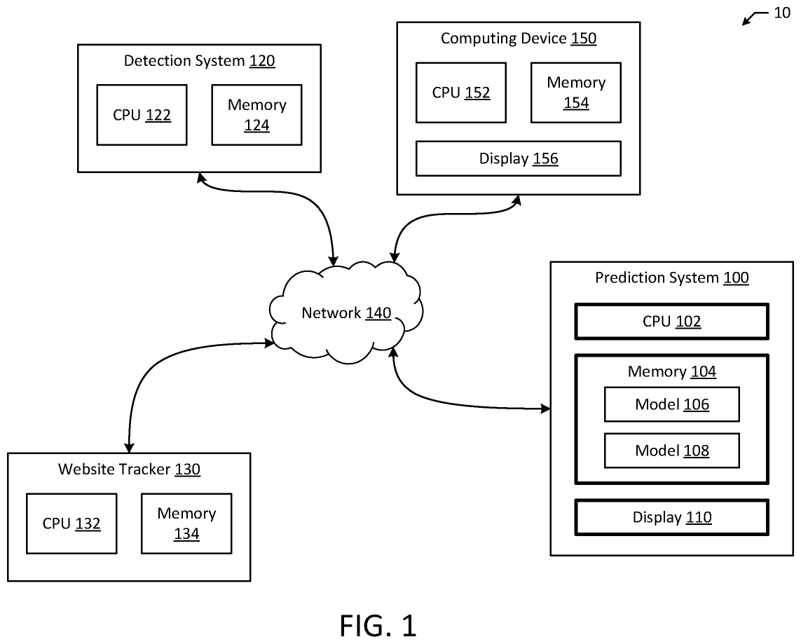

FIG. 1 illustrates an example computer network 10 (e.g., a telecommunications network) that may be used to implement various aspects of the present application. Generally, the computer network 10 includes various devices communicating and functioning together in the gathering, transmitting, and/or requesting of data related to evaluating marketing campaigns. As illustrated, a communications network 140 allows for communication in the computer network 10. The communications network 140 may include one or more wireless networks such as, but not limited to one or more of a Local Area Network (LAN), Wireless Local Area Network (WLAN), a Personal Area Network (PAN), Campus Area Network (CAN), a Metropolitan Area Network (MAN), a Wde Area Network (WAN), a Wireless Wde Area Network (WWAN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, LTE networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols. The communications network 140 may also include wired networks.

A prediction system 100 having a processor in communication with a memory 104 may predict an amount of web traffic to a website given certain input parameters. The processor may be a CPU 102, an ASIC, or any other similar device. In some aspects, the prediction system 100 may have a display 110 suitable for displaying electronic data, and in some instances, may be a touchscreen display. To make its predictions, the prediction system 100 may store one or more machine learning models (e.g., models 106 and 108) in the memory 104.

Machine learning models (e.g., the models 106 and 108), as described herein, may include negative binomial distributions, support vector machines, logistic regression techniques, linear discriminant analysis, linear regression analysis, artificial neural networks, recurrent neural networks, convolution neural networks, machine learning classifier algorithms, or classification/regression trees in some embodiments. In various other embodiments, machine learning systems may employ Naive Bayes predictive modeling analysis of several varieties, learning vector quantization artificial neural network algorithms, or implementation of boosting algorithms such as CatBoost, XGBoost, and AdaBoost, or stochastic gradient boosting systems for iteratively updating weighting to train a machine learning classifier to determine a relationship between an influencing attribute, such as received image data, and a brand logo classification and/or a degree to which such an influencing attribute affects the outcome of such brand logo classification.

Though not limiting, the inventors have found that a negative binomial distribution model works particularly well for the models 106 and 108 since a negative binomial distribution underlies the stochasticity in over-dispersed count data. Over-dispersed count data means that the data have a greater degree of stochasticity than what one would expect from the Poisson distribution, which is frequently the case for count data arising in epidemic or population dynamics due to randomness in population movements or contact rates, and/or deficiencies in the model in capturing all intricacies of the population dynamics.

In various aspects, the model 106 may be trained to predict an amount of web traffic to a website in the absence of any attributable events that could cause the web traffic to spike, such as a TV commercial airing that is related to a product sold on the website. Stated differently, the model 106 may be trained to predict a baseline amount of web traffic to a website that the website typically experiences when nothing is driving extra traffic to the website. This predicted baseline amount of web traffic can be compared to actual web traffic data received from a website tracker 130 in order to determine an attributable event's effect on traffic to the website. In at least some aspects, the output of the model 106 may include quantiles of the distribution of the predicted traffic. An example process for training the model 106 will be described below.

In various aspects, the model 108 may be trained to predict web traffic to a website based on one or more changeable variables. Stated differently, a user may select and/or adjust one or more input parameters for the model 108 which then predicts an amount of web traffic to the website if those input parameters were to be true. For instance, a user may desire information on what web traffic would have been like to the website had certain variables been different (e.g., a TV commercial presented on a different channel) in order to assess the variables of a current marketing campaign. In another instance, a user may desire information on what web traffic would be to a website in the future given certain variables should a marketing campaign be launched with those variables. In at least some aspects, the output of the model 108 may include quantiles of the distribution of the predicted traffic. The model 108 therefore enables a user to evaluate the various aspects of a current marketing campaign or a proposed future marketing campaign.

The model 108 may be trained with data obtained based on outputs from the model 106 in at least some aspects of the present application. For example, in one instance, web traffic during a time window associated with presentation of a TV commercial on a first channel (e.g., NBC®) may be compared to web traffic predicted by the model 106 during that time window. In another instance, web traffic during a time window associated with presentation of the TV commercial on a second channel (e.g., CBS®) may be compared to web traffic predicted by the model 106 during that time window. The model 108 may be trained by the comparison data from each of these instances, among many other like instances, in order to learn the effect that airing a TV commercial on a particular channel has on web traffic. Similar training is done for other attributable events, and in this way, the model 108 is able to predict web traffic based on a given set of input variables.

Each of the models 106 and 108 may be trained with an amount of data that the human mind is unable to sort and process. As such, a human mind is unable to generate the outputs produced by each of the models 106 and 108, but rather a system with sufficient computing capabilities is needed to generate such outputs. In various aspects, input parameters to the model 106 and/or the model 108 may include a granularity of the time series in the training data, a maximum number of passes over the training data, a number of epochs within which training stops when no progress is made, a size of mini-batches used during training, a learning rate used in training, a number of time-points that the model 106 and/or 108 gets to see before making a prediction, and a number of time-steps that the model 106 and/or 108 is trained to predict.

The computing device 150 may be any suitable device capable of presenting media. For example, the computing device 150 may be a smart TV, smartphone, tablet, computer, or laptop. In some aspects, the computing device 150 may be capable of communicating over the network 140. The computing device 150 may include a processor in communication with a memory 154. The processor may be a CPU 152, an ASIC, or any other similar device. The computing device 150 may also include a display 156, which in some aspects may be a touch display.

The detection system 120 may be any suitable system for detecting the occurrence of an attributable event, such as an attributable event occurring at the computing device 150. For example, the detection system 120 may use an inaudible audio and/or video watermark or other type of unique identifier, embedded or otherwise encoded in a broadcast signal, to identify the start (and possibly end) of an advertisement (or other program), or that a particular keyword, phrase, image, etc. was presented in the advertisement. In another example, the detection system 120 may consume content feeds (e.g., via API or web scraping tools to crawl websites) to extract text from the content feeds and analyze the extracted text (e.g., using natural language processing or other suitable machine learning or artificial intelligence techniques) to identify events, such as weather, political, or cultural events. Upon detecting the occurrence of an attributable event, the detection system 120 may transmit an electronic signal to the prediction system 100 indicating the detection of an attributable event. The detection system 120 may include a processor in communication with a memory 124. The processor may be a CPU 122, an ASIC, or any other similar device.

The website tracker 130 may be any suitable system (e.g., Google Analytics) for tracking website traffic to a website. In some aspects, the website tracker 130 may include a processor in communication with a memory 134. The processor may be a CPU 132, an ASIC, or any other similar device.

In an illustrative usage scenario, the detection system 120 identifies that presentation of a company's TV commercial has started at the computing device 150. The detection system 120 then transmits a signal indicating such to the prediction system 100. Using the model 106, the prediction system 100 predicts what the web traffic to the company's website would have been for a time window (e.g., 5 minutes) after receiving the signal had the company's TV commercial not been presented. The prediction system 100 also acquires or receives web traffic data for the company's website from the website tracker 130. The web traffic data may include metrics (e.g., amount) on the actual traffic to the company's website within the time window. In some instances, the prediction system 100 may receive a signal from the detection system 120 indicating that the company's TV commercial has ended and the time window may be relative to the end of the company's TV commercial (e.g., a 5 minute window after the end time). The prediction system 100 may then compare the actual web traffic to the company's website with the predicted web traffic in order to identify the change in web traffic caused by the TV commercial. It will be appreciated that this illustrative usage scenario is merely exemplary and not limiting in view of the various aspects described herein.

In some aspects of the present application, the components of the computer network 10 may be combined, rearranged, or removed. For example, two or more of the prediction system 100, the detection system 120, the website tracker 130, and the computing device 150 may be combined into a single system.

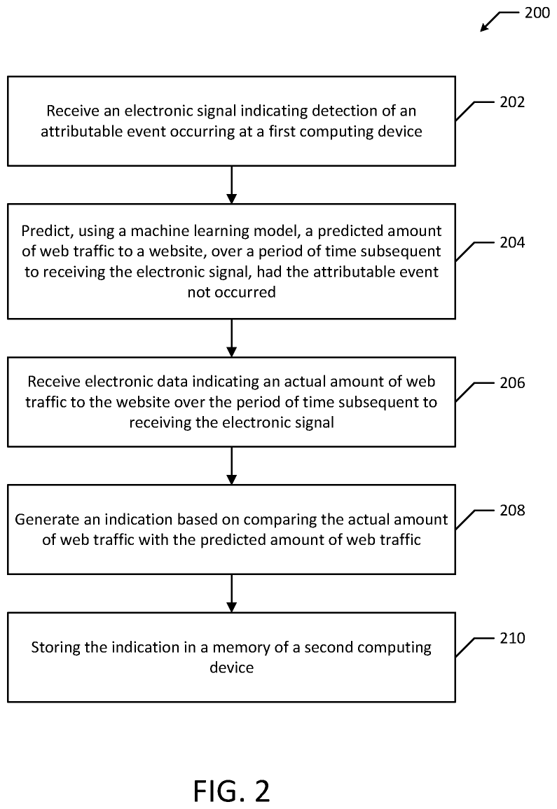

FIG. 2 illustrates a flow chart of an example process 200 for generating an indication that may be implemented and/or executed by the prediction system 100 and/or the computing network 10. At block 202, an electronic signal may be received (e.g., by the prediction system 100) indicating detection of an attributable event. For example, the prediction system 100 may receive the electronic signal from the detection system 120. The attributable event may occur at a computing device (e.g., the computing device 150). For example, a TV commercial may be presented at the computing device 150. At block 204, the prediction system 100 may predict, using a machine learning model (e.g., the model 106), a predicted amount of web traffic to a website, over a period of time subsequent to receiving the electronic signal, had the attributable event not occurred. As described above, the predicted amount of web traffic serves as a baseline from which to evaluate the effect of an attributable event on web traffic. The period of time may be a sufficient time window (e.g., 2, 5, 10, 15 minutes) during which a change in web traffic may typically be seen following an attributable event occurring, and may be set by the user.

At block 206, the prediction system 100 may receive electronic data indicating an actual amount of web traffic to the website over the period of time subsequent to receiving the electronic signal. For example, the prediction system 100 may receive web traffic data from the website tracker 130. At block 208, the prediction system 100 may generate an indication based on comparing the actual amount of web traffic with the predicted amount of web traffic. Stated differently, the prediction system 100 compares what actually happened (e.g., the actual amount of web traffic) when the attributable event occurred with what would have happened (e.g., the predicted amount of web traffic) had the attributable event not occurred in order to evaluate the attributable event's effect. In this way, the attributable event's effect on web traffic can be more accurately determined with the new and innovative baseline traffic prediction process as compared to typical methods that rely solely upon historical data. At block 210, the prediction system 100 may store the generated indication in a memory of a computing device (e.g., the memory 104).

The generated indication may include various metrics related to the attributable event, such as the predicted web traffic, the actual web traffic, and the difference between the two. The generated indication may, additionally or alternatively, include various advertiser-focused metrics related to web traffic, such as sales, customer conversion, and lift attribution. For example, the prediction system 100 may generate an attribution score for an attributable event that scores how effective the attributable event was at generating sales. An advertiser may then use the indication to evaluate the advertiser's marketing campaign.

In some cases, the advertiser may desire to evaluate a marketing campaign by analyzing how web traffic might have been different if certain variables of the marketing campaign were changed. As such, in some aspects, the process 200 may further include the prediction system 100 predicting, using a second machine learning model (e.g., the model 108), a second predicted amount of web traffic to the website over the period of time subsequent to receiving the electronic signal with one or more variables of the marketing campaign being changed. For example, these variables may include, but are not limited to, a type of advertisement, a TV market within which the advertisement is shown, a particular network affiliate or streaming platform through which the advertisement is ran, a particular channel on which the advertisement is presented, a particular time (e.g., time of day, day, week, month, year, or season) during which the advertisement is presented, content (e.g., a keyword, phrase, image, etc.) being presented in the advertisement, the TV program the advertisement runs during, the content (e.g., topics, keywords, brands, people, political figures, etc.) being discussed within the TV program, and associated sentiment (e.g. positive or negative) of that content, or other metadata or categorization which may be commonly used to describe the TV program or TV program content (e.g. syndication status, the cast of the show, ratings, rankings, critiques, etc.), a percent reach to which the advertisement was shown (e.g., a percentage of the US population), the search engine a paid advertisement is run on, the social media platform an advertisement is run on, the coordination of paid advertising efforts on search and social platforms in sync with the advertising, the demographic, psychographic, or other measurable characteristics of the audience, household, or individual to which the advertisement is being shown, and the particular frequency of which an advertisement is shown to a certain audience, household or individual.

As described above, the model 108 may be trained to predict web traffic based on various combinations of input variables. The indication may be generated based on the second predicted amount of web traffic, in addition to or alternatively to, being based on the first predicted amount of web traffic.

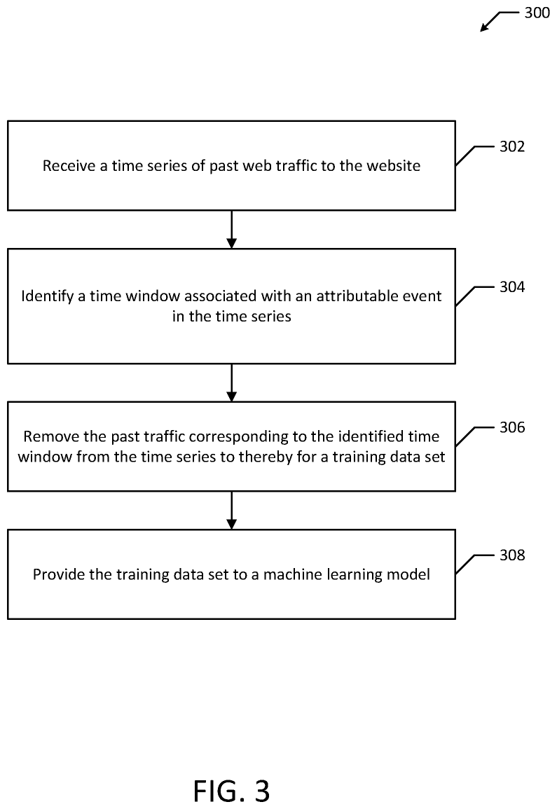

FIG. 3 illustrates a flow chart of an example process 300 for training a machine learning model (e.g., the model 106) that predicts baseline web traffic for a website, and which may be implemented and/or executed by the prediction system 100 and/or the computing network 10. Training the model 106 may take place prior its use in making predictions (e.g., prior to execution of the example process 200). In some aspects, the model 106 may be trained by a separate computing system prior to being integrated with the prediction system 100. At block 302, the prediction system 100 may receive a time series of past web traffic to a website. In this case, past web traffic means any web traffic that has occurred prior to the next time the model 106 will be used to predict web traffic. Stated differently, the model 106 may be continually trained with new data over time and therefore past web traffic is not limited to only data prior to its first use. In at least some aspects, the time series of past web traffic is to one particular website.

At block 304, the prediction system 100 may identify a time window associated with an attributable event in the time series. This may be accomplished, for example, by identifying a time at which an attributable event occurred and creating a time window relative to that time, such as a time window equal to a predetermined amount of time (e.g., 10 minutes) beginning at the time at which the attributable event occurred. This time window can then be identified in the time series of past web traffic. At block 306, the prediction system 100 may remove the past web traffic corresponding to the identified time window from the time series to thereby form a training data set. Blocks 304 and 306 may be repeated as many times as needed in order to remove all of the past web traffic from the time series that corresponds to attributable events. In this way, any change in web traffic caused by an attributable event is removed from the training data set such that only a baseline level of web traffic to the website remains.

At block 308, the prediction system 100 provides the training data set to the model 106 to thereby train the model 106. Training the model 106 in this new and innovative way so that the model 106 may predict baseline levels of web traffic enables evaluating marketing campaigns through the lens of a variety of attributable events (e.g. multiple data streams) as compared to the technologically limited typical methods that rely on solely historical data (e.g., a single data stream).

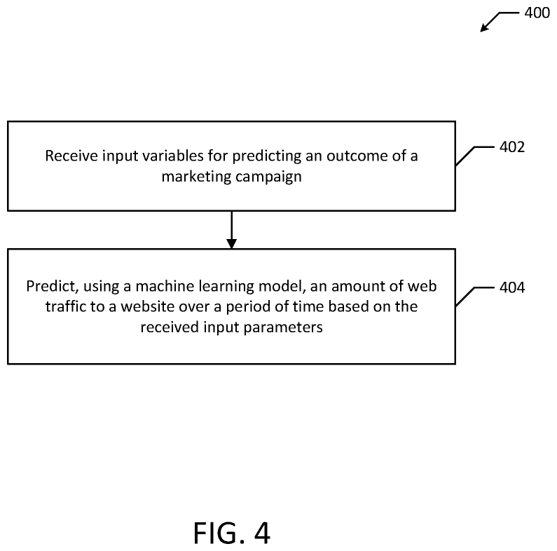

FIG. 4 illustrates a flow chart of an example process 400 for predicting an amount of web traffic to a website based on input marketing campaign variables, which enables a user to test the outcome of a proposed marketing campaign with different combinations of variables. The process 400 may be implemented and/or executed by the prediction system 100 and/or the computing network 10. At block 402, input variables may be received (e.g., by the prediction system 100) for predicting an outcome of a marketing campaign. For example, these input variables may include the changeable marketing campaign variables discussed above in connection with the process 200. At block 404, the prediction system 100 may predict, using a machine learning model (e.g., the model 108), an amount of web traffic to a website over a period of time based on the received input parameters. The period of time may be a sufficient time window (e.g., 2, 5, 10, 15 minutes) during which a change in web traffic may typically be seen following an attributable event occurring, and may be set by the user.

Each of FIGS. 2-4 shows a flow chart of an example process. Although the example processes 200, 300, and 400 are described with reference to the respective flow charts illustrated in FIGS. 2-4, it will be appreciated that many other methods of performing the acts associated with the processes 200, 300, and 400 may be used. For example, in each respective process 200, 300, and 400, the order of some of the blocks may be changed, certain blocks may be combined with other blocks, and some of the blocks described are optional. In another example, one or more blocks from one process (e.g., the process 400) may be combined with another process (e.g., the process 200). The processes 200, 300, and 400 may be performed by processing logic that may comprise hardware (circuitry, dedicated logic, etc.), software, or a combination of both.

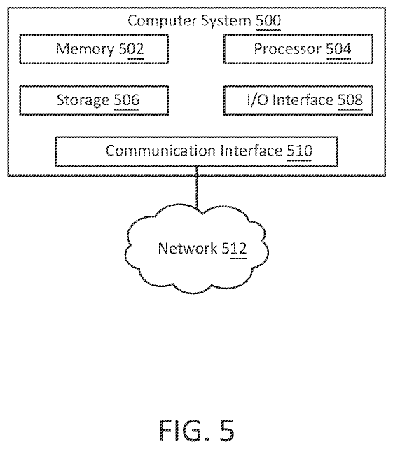

FIG. 5 illustrates an example computer system 500 that may be utilized to implement one or more of the devices and/or components of the disclosed system. In particular embodiments, one or more computer systems 500 perform one or more steps of one or more methods described or illustrated herein. In particular embodiments, one or more computer systems 500 provide the functionalities described or illustrated herein. In particular embodiments, software running on one or more computer systems 500 performs one or more steps of one or more methods described or illustrated herein or provides the functionalities described or illustrated herein. Particular embodiments include one or more portions of one or more computer systems 500. Herein, a reference to a computer system may encompass a computing device, and vice versa, where appropriate. Moreover, a reference to a computer system may encompass one or more computer systems, where appropriate.

This disclosure contemplates any suitable number of computer systems 500. This disclosure contemplates the computer system 500 taking any suitable physical form. As example and not by way of limitation, the computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 504, memory 502, storage 506, an input/output (I/O) interface 508, and a communication interface 510. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 504 includes hardware for executing instructions, such as those making up a computer program. As an example and not by way of limitation, to execute instructions, the processor 504 may retrieve (or fetch) the instructions from an internal register, an internal cache, memory 502, or storage 506; decode and execute the instructions; and then write one or more results to an internal register, internal cache, memory 502, or storage 506. In particular embodiments, the processor 504 may include one or more internal caches for data, instructions, or addresses. This disclosure contemplates the processor 504 including any suitable number of any suitable internal caches, where appropriate. As an example and not by way of limitation, the processor 504 may include one or more instruction caches, one or more data caches, and one or more translation lookaside buffers (TLBs). Instructions in the instruction caches may be copies of instructions in memory 502 or storage 506, and the instruction caches may speed up retrieval of those instructions by the processor 504. Data in the data caches may be copies of data in memory 502 or storage 506 that are to be operated on by computer instructions; the results of previous instructions executed by the processor 504 that are accessible to subsequent instructions or for writing to memory 502 or storage 506; or any other suitable data. The data caches may speed up read or write operations by the processor 504. The TLBs may speed up virtual-address translation for the processor 504. In particular embodiments, processor 504 may include one or more internal registers for data, instructions, or addresses. This disclosure contemplates the processor 504 including any suitable number of any suitable internal registers, where appropriate. Where appropriate, the processor 504 may include one or more arithmetic logic units (ALUs), be a multi-core processor, or include one or more processors 504. Although this disclosure describes and illustrates a particular processor, this disclosure contemplates any suitable processor.

In particular embodiments, the memory 502 includes main memory for storing instructions for the processor 504 to execute or data for processor 504 to operate on. As an example, and not by way of limitation, computer system 500 may load instructions from storage 506 or another source (such as another computer system 500) to the memory 502. The processor 504 may then load the instructions from the memory 502 to an internal register or internal cache. To execute the instructions, the processor 504 may retrieve the instructions from the internal register or internal cache and decode them. During or after execution of the instructions, the processor 504 may write one or more results (which may be intermediate or final results) to the internal register or internal cache. The processor 504 may then write one or more of those results to the memory 502. In particular embodiments, the processor 504 executes only instructions in one or more internal registers or internal caches or in memory 502 (as opposed to storage 506 or elsewhere) and operates only on data in one or more internal registers or internal caches or in memory 502 (as opposed to storage 506 or elsewhere). One or more memory buses (which may each include an address bus and a data bus) may couple the processor 504 to the memory 502. The bus may include one or more memory buses, as described in further detail below. In particular embodiments, one or more memory management units (MMUs) reside between the processor 504 and memory 502 and facilitate accesses to the memory 502 requested by the processor 504. In particular embodiments, the memory 502 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 502 may include one or more memories 502, where appropriate. Although this disclosure describes and illustrates particular memory implementations, this disclosure contemplates any suitable memory implementation.

In particular embodiments, the storage 506 includes mass storage for data or instructions. As an example and not by way of limitation, the storage 506 may include a hard disk drive (HDD), a floppy disk drive, flash memory, an optical disc, a magneto-optical disc, magnetic tape, or a Universal Serial Bus (USB) drive or a combination of two or more of these. The storage 506 may include removable or non-removable (or fixed) media, where appropriate. The storage 506 may be internal or external to computer system 500, where appropriate. In particular embodiments, the storage 506 is non-volatile, solid-state memory. In particular embodiments, the storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. The storage 506 may include one or more storage control units facilitating communication between processor 504 and storage 506, where appropriate. Where appropriate, the storage 506 may include one or more storages 506. Although this disclosure describes and illustrates particular storage, this disclosure contemplates any suitable storage.

In particular embodiments, the I/O Interface 508 includes hardware, software, or both, providing one or more interfaces for communication between computer system 500 and one or more I/O devices. The computer system 500 may include one or more of these I/O devices, where appropriate. One or more of these I/O devices may enable communication between a person and computer system 500. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 508 may include one or more device or software drivers enabling processor 504 to drive one or more of these I/O devices. The I/O interface 508 may include one or more I/O interfaces 508, where appropriate. Although this disclosure describes and illustrates a particular I/O interface, this disclosure contemplates any suitable I/O interface or combination of I/O interfaces.

In particular embodiments, communication interface 510 includes hardware, software, or both providing one or more interfaces for communication (such as, for example, packet-based communication) between computer system 500 and one or more other computer systems 500 or one or more networks 512. As an example and not by way of limitation, communication interface 510 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 512 and any suitable communication interface 510 for it. As an example and not by way of limitation, the network 512 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface implementations, this disclosure contemplates any suitable communication interface implementation.

The computer system 500 may also include a bus. The bus may include hardware, software, or both and may communicatively couple the components of the computer system 500 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

The invention is claimed as follows:

1. A method for evaluating a marketing campaign, comprising:
receiving an electronic signal indicating detection of an attributable event occurring at a first computing device;
predicting, using a machine learning model, a predicted amount of web traffic to a website, over a period of time subsequent to receiving the electronic signal, had the attributable event not occurred;
receiving electronic data indicating an actual amount of web traffic to the website over the period of time subsequent to receiving the electronic signal;
generating an indication based on comparing the actual amount of web traffic with the predicted amount of web traffic; and
storing the indication in a memory of a second computing device.

2. The method of claim 1, further comprising training the machine learning model, which includes:
receiving a time series of past web traffic to the website prior to receiving the electronic signal;
identifying a time window associated with an attributable event in the time series;
removing the past web traffic corresponding to the identified time window from the time series to thereby form a training data set; and
providing the training data set to the machine learning model.

3. The method of claim 1, wherein the attributable event is one included in the group consisting of: an advertisement being presented in general, a type of advertisement, a manner in which an advertisement is presented, the content discussed within a TV program during which the advertisement is presented, an associated sentiment of the TV program content, a search and social platform paid advertisement bid, a weather event, a political event, and a cultural event.

4. The method of claim 3, wherein the content is a phrase or keyword.

5. The method of claim 3, wherein the type of advertisement is a TV commercial.

6. The method of claim 3, wherein generating the indication includes determining an attribution value for the attributable event based on comparing the actual amount of web traffic with the predicted amount of web traffic.

7. The method of claim 1, further comprising training a second machine learning model based on the comparing of the actual amount of web traffic with the predicted amount of web traffic.

8. The method of claim 1, further comprising predicting, using a second machine learning model, a second predicted amount of web traffic to the website over the period of time subsequent to receiving the electronic signal with one or more variables of the marketing campaign being changed, wherein the indication is generated based additionally on the second predicted amount of web traffic.

9. The method of claim 8, wherein the variables of the marketing campaign include at least one in the group consisting of: a type of advertisement, a TV market within which an advertisement is shown, a particular network affiliate or streaming platform through which an advertisement is ran, a particular channel on which an advertisement is presented, a particular time during which an advertisement is presented, content being presented in an advertisement, the TV program an advertisement runs during, the content being discussed within the TV program, associated sentiment of the TV program content, a percent reach to which an advertisement was shown, the search engine an advertisement is run on, the social media platform an advertisement is run on, characteristics of the audience, household, or individual to which an advertisement is being shown, and the particular frequency of which an advertisement is shown to a certain audience, household or individual.

10. The method of claim 8, wherein the second machine learning model is trained with the generated indication.

11. A system for evaluating a marketing campaign, comprising:
a memory; and
a processor in communication with the memory, the processor configured to:
receive an electronic signal indicating detection of an attributable event occurring at a computing device;
predict, using a machine learning model, a predicted amount of web traffic to a website, over a period of time subsequent to receiving the electronic signal, had the attributable event not occurred;
receive electronic data indicating an actual amount of web traffic to the website over the period of time subsequent to receiving the electronic signal;
generate an indication based on comparing the actual amount of web traffic with the predicted amount of web traffic; and
store the indication in the memory.

12. The system of claim 11, wherein the machine learning model is trained based on a time series of past web traffic to the website in which the web traffic associated with past attributable events is removed from the time series.

13. The system of claim 11, wherein the processor is further configured to predict, using a second machine learning model, a second predicted amount of web traffic to the website over a period of time subsequent to generating the indication.

14. The system of claim 11, wherein the machine learning model is a negative binomial distribution.

15. The system of claim 11, wherein the attributable event is a TV commercial airing, and wherein the indication includes a lift attribution value for the TV commercial.

16. The system of claim 11, wherein the processor is further configured to predict, using a second machine learning model, a second predicted amount of web traffic to the website over the period of time subsequent to receiving the electronic signal with one or more variables of the marketing campaign being changed, wherein the indication is generated based on the second predicted amount of web traffic.

17. The system of claim 16, wherein the second machine learning model is trained based on the comparing of the actual amount of web traffic with the predicted amount of web traffic.

18. A non-transitory, computer-readable medium storing instructions, which when executed by a processor, cause the processor to:
receive an electronic signal indicating detection of an attributable event occurring at a first computing device;
predict, using a machine learning model, a predicted amount of web traffic to a website, over a period of time subsequent to receiving the electronic signal, had the attributable event not occurred;
receive electronic data indicating an actual amount of web traffic to the website over the period of time subsequent to receiving the electronic signal;
generate an indication based on comparing the actual amount of web traffic with the predicted amount of web traffic; and
store the indication in a memory of a second computing device.

19. The non-transitory, computer-readable medium of claim 18, wherein the machine learning model is trained only on web traffic data associated with the website.

20. The non-transitory, computer-readable medium of claim 18, wherein the indication includes at least one metric in the group consisting of: an amount in sales associated with the attributable event, a customer conversion rate associated with the attributable event, and lift attribution of the attributable event.
